(19) United States
(12) Patent Application Publication
(10) Pub. No.: US 2010/0153877 A1
(43) Pub. Date: Jun. 17, 2010

(54) Task Switching

(76) Inventors: Mika Antero Rautava, Espoo (FI); Ming Han Lee, Helsinki (FI); Guido Grassel, Espoo (FI)

Correspondence Address: Hollingsworth & Funk, 8500 Normandale Lake Blvd., Suite 320, Minneapolis, MN, 55437, US

(21) Appl. No.: 12/332,850

(22) Filed: Dec. 11, 2008

(51) Int. Cl. G06F 3/048

(52) U.S. Cl. 715/802

(57) ABSTRACT

A user interface for switching between applications is provided. The user interface comprises control means for executing a first and a second application, for displaying the first application as a main application, for receiving a first input and in response thereto displaying the second application as a main application. The user interface also comprises control means for executing a plurality of applications, and control means for displaying one of said applications, for receiving a second input and for marking the displayed application as an alternate application.

### FIELD

The present application relates to a user interface, a device and a method for improved switching between tasks, and in particular to a user interface, a device and a method for improved switching between tasks by employing tactile input.

### BACKGROUND

More and more electronic devices such as mobile phones, MP3 players, Personal Digital Assistants (PDAs) are becoming smaller and smaller while having more and more information stored and/or accessible through them. Users are relying on these devices and becoming all the more dependant on them. The environments in which these devices are used are also becoming more and more hectic with higher demands on fast access and multitasking, and not only in a professional environment but also in private and social environments.

A device that allows fast and easy switching of applications would thus be useful in modern day society

### SUMMARY

On this background, it would be advantageous to provide a user interface, a device and a method that overcomes or at least reduces the drawbacks indicated above by providing a device having an improved switching between applications according to the claims.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a front view of a device according to an embodiment,

FIG. 3 is a block diagram illustrating the general architecture of a device of FIG. 2 in accordance with the present application,

FIGS. 4-8 are schematic views of applications being executed on a device according to an embodiment,

FIGS. 9a-9d are schematic views of applications being executed on a device according to an embodiment,

FIGS. 10a-10d are schematic views of applications being executed on a device according to an embodiment, and

FIG. 11 is a flow chart describing a method according to an embodiment of the application.

### DETAILED DESCRIPTION

In the following detailed description, the user interface, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

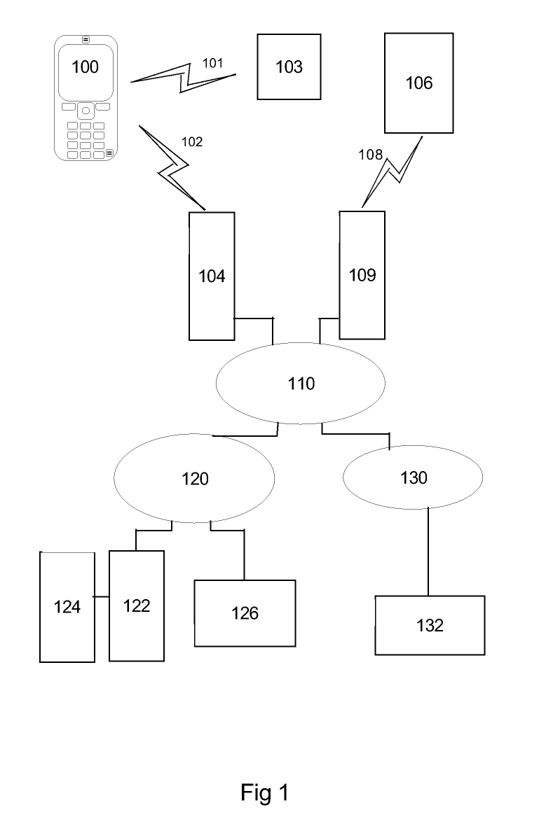

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Speciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

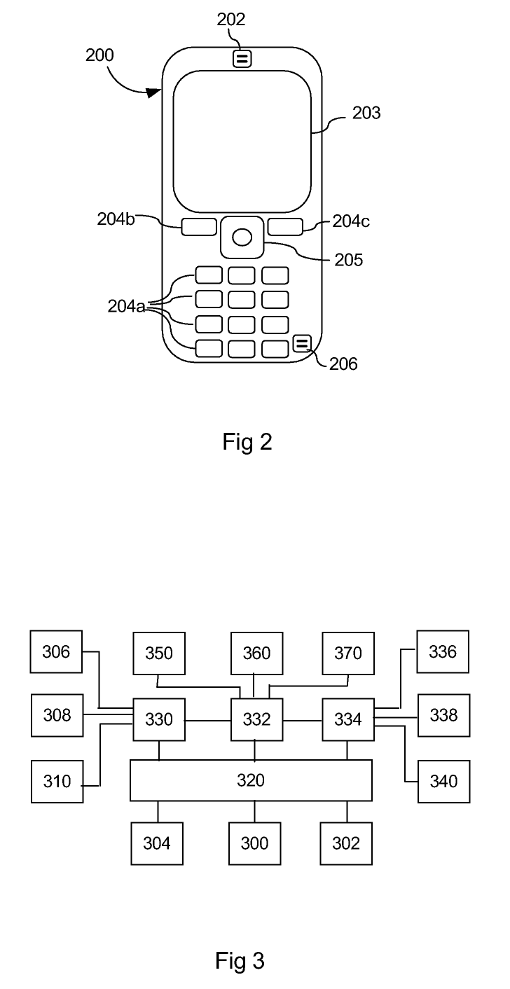

An embodiment 200 of the mobile terminal 100 is illustrated in more detail in FIG. 2. The mobile terminal 200 comprises a speaker or earphone 202, a microphone 206, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving messages such as Short Message Service (SMS), Multimedia Message Service (MMS) or email, web browsing, an instant messaging application, a phone book application, a calendar application, a control panel application, a camera application, one or more video games, etc. It should be noted that two or more of the applications listed above may be executed as the same application.

The memory 302 is one example of a computer readable medium. Other examples of computer readable mediums are diskettes, CD-ROMS (Compact Disc ROMS), DVDs (Digital Video Discs), Universal Serial Bus (USB) memory sticks, and memory cards such as Secure Digital (SD) memory cards. A computer readable medium can also be at least a portion of a storage device such as a hard drive or other used in a server for storing software to be downloaded to a client.

The MMI 334 also includes one or more hardware controllers, which together with the MMI drivers cooperate with the first display 336/203, and the keypad 338/204 as well as various other Input/Output devices such as microphone, speaker, vibrator, ringtone generator, LED indicator, etc. In particular the MMI includes a tactile input means 340. Such tactile input means 340 are commonly known to be possible to be implemented through a gyroscope or an accelerometer. Such tactile input means allow a user to give tactile input to a device. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

In one embodiment according to the teachings herein a controller is arranged to receive tactile input and in response thereto switch from displaying a first application as a main application to display a second application as a main application.

In a further embodiment a controller is arranged to receive tactile input and in response thereto mark a specific view for easier switching.

In one embodiment the tactile input e.g. either a shake or a twist. A twist can be directional and in this way indicate in what way to scroll through active applications that are arranged in a list.

In one embodiment the controller is also arranged to receive input through a physical or virtual key and in response thereto switch between the applications. In one embodiment the application selection scheme is different for tactile input indicating an application switch than it is for an input through a physical or virtual key.

In one embodiment tactile input switching only switches between applications that have previously been marked as alternate applications. In one embodiment the list of applications are rearrange according to which applications are marked or not. In one embodiment the list is arranged with a nestled list structure thus maintaining the marking within the original list. A nestled list is to be understood as two list structures re-using the items common to both lists.

In one embodiment tactile input switches between marked or alternate applications.

In one embodiment key originating input switches between unmarked applications.

In one embodiment key originating input switches between applications irrespective of marking.

In one embodiment a tactile input switches between marked applications, while repeated tactile input switches between applications irrespective of marking.

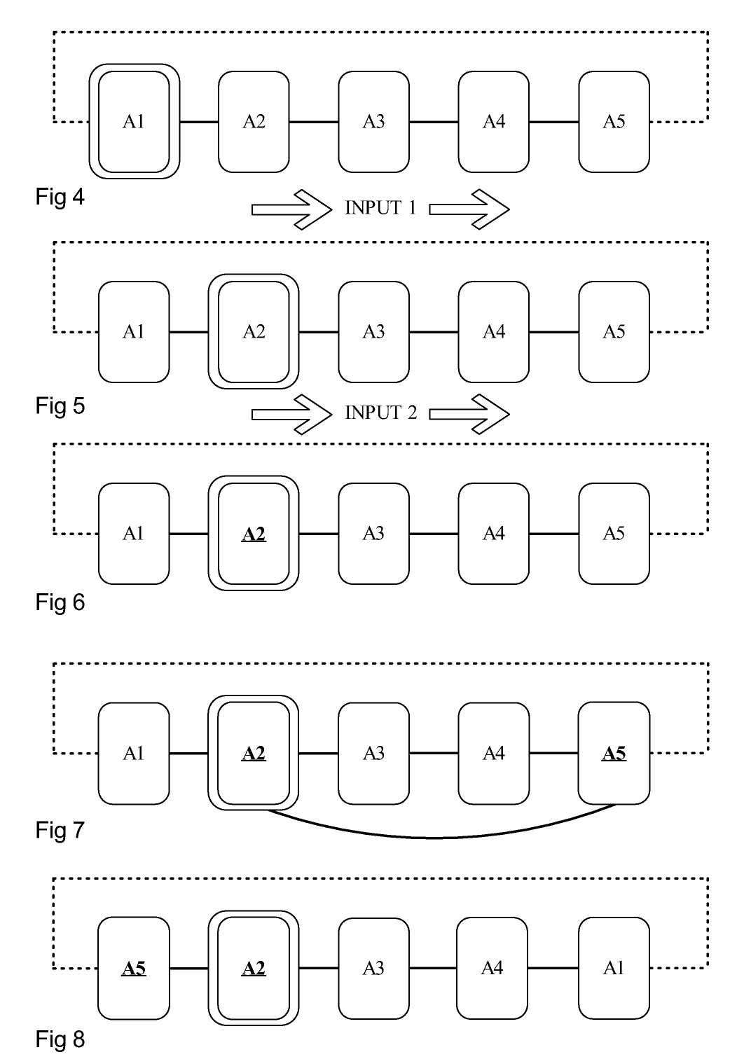

FIGS. 4 to 10 show schematic views of applications being executed by a controller (300) in a device (200). The applications A1 to A5 are arranged in a linked list. As is indicated by the dashed line the list may be circular.

The list of application may be constructed in a number of ways and the order of the applications in the list may depend on a number of design options such as last used or frequency of use.

It should also be noted that even though it is not shown in the figure, the list may be rearranged as an application is selected to be displayed as a main application.

In FIG. 4 a first application A1 is indicated to be currently displayed as a main application by the frame around it.

The controller (300) is arranged to receive a first input (as indicated by the arrow) and in response thereto display a second application A2 as a main application, as is indicated in FIG. 5 by the frame around application A2.

In one embodiment the first input is a press on a dedicated application switching button (not shown).

In one embodiment the first input is a tactile input represented by a shaking motion.

In one embodiment the first input is a tactile input representing a twisting motion. In the below it will be assumed that the first input is a tactile input representing a twisting motion.

In one embodiment the first input represents a direction and the application to be switched to is chosen according to the direction. In one embodiment a twist to the right indicates that an application to the right in the list should be selected, in the case of FIG. 5 A3 would be selected to be displayed as a main application. Likewise a twist to the left would indicate that an application to the left in the list should be selected, in the case of FIG. 5 application A1 would be selected. In an embodiment where the order of the applications in the list is according to frequency of use this allows a user to associate a direction with a frequency of use. This enables a user to select a frequently used application by twisting in one direction and to select a less frequently used application by twisting in another direction.

Returning to FIG. 5, if a second input is received the controller (300) is arranged to mark an application as an alternate application. This is indicated in FIG. 6 by the denomination of A2 being underlined and in bold characters. Enabling the marking of applications as alternate applications allows the controller to keep track of applications that a user finds to be of special interest. A user is prone to want to return to such applications repeatedly and is thus in a need of a simple and intuitive manner of switching between those.

In one embodiment the second input is a press on a dedicated application marking button (not shown).

In one embodiment the second input is a tactile input represented by a twisting motion.

In one embodiment the second input is a tactile input representing a shaking motion. In the below it will be assumed that the second input is a tactile input representing a shaking motion.

In one embodiment the controller is arranged to maintain the alternate applications A2 and A5 in a separate list structure. This is indicated in FIG. 7 by an arched line between application A2 and A5.

In one embodiment the controller is arranged to re-arrange the list of applications A1 to A5 so that alternate applications A2 and A5 are grouped together. This is indicated in FIG. 8 by the alternate or marked applications A2 and A5 being in the beginning of the list of applications A1 to A5.

There are several possibilities of allowing a user to switch between alternate applications and to generally switch application. In one embodiment (not shown) an input given once always switches to an alternate application, but a repeated input switches to an application selected according to the list structure.

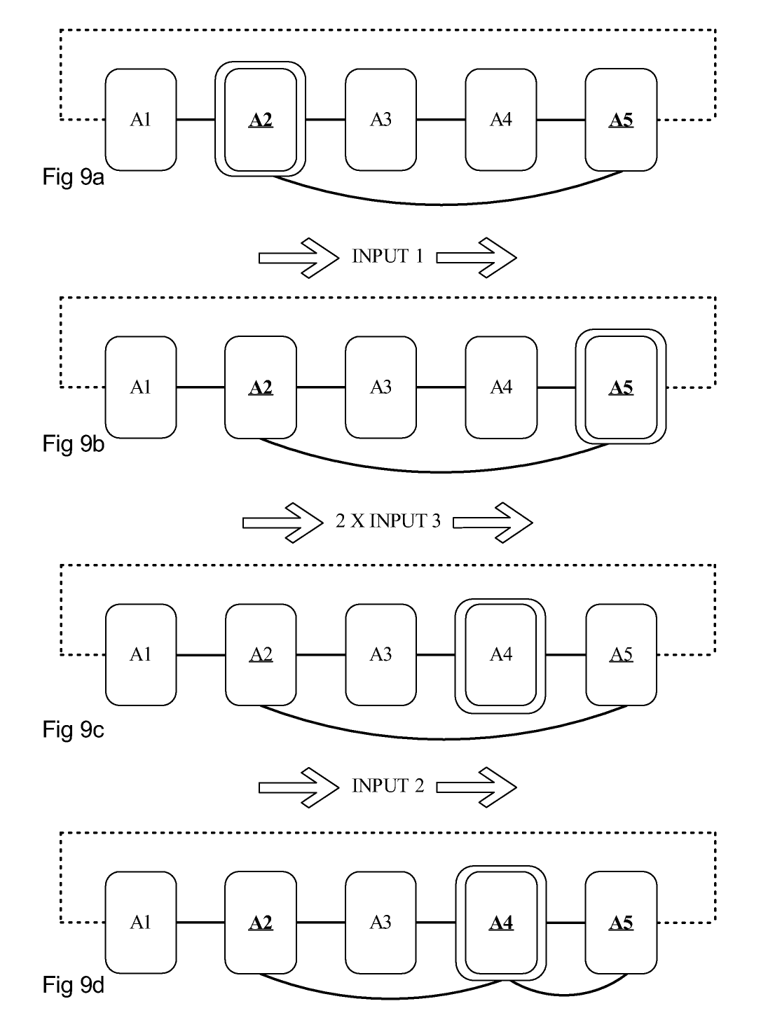

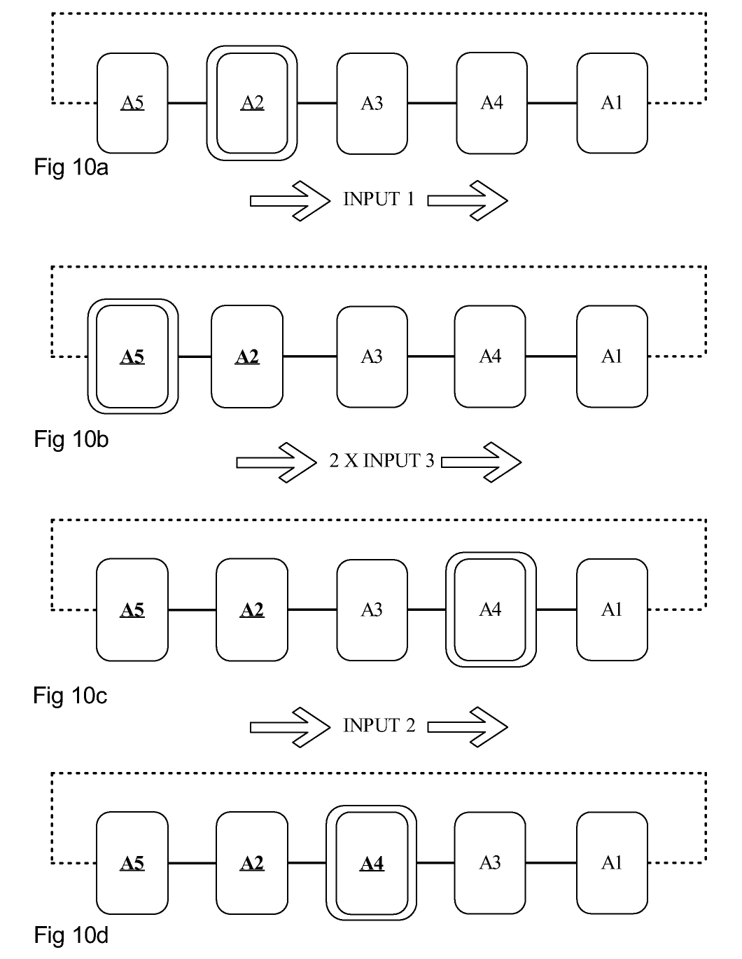

In an alternative embodiment, see FIG. 9 which uses the list structure of FIG. 7, a user can order an application switch to an alternate application A2 or A5 by providing a first input, in this embodiment a tactile input representing a twisting motion. In FIG. 9a an alternate application A2 is currently being displayed as a main application. A user twists a device (not shown) implementing a user interface according to this embodiment and a controller receives the input. The controller selects the other alternate application A5 to be switched to and displays it as a main application. See FIG. 9b where application A5 is marked with a frame as being currently displayed as a main application. Note that application A5 is not next to application A2 in the list structure but the controller follows the alternate route indicated by the arched line from A2 to A5 to select the next application to be displayed as a main application. If a further first input would be received the controller would switch and display application A1 as a main application, i.e. return to FIG. 9a.

Returning to FIG. 9a, if a user provides a third input the controller is arranged to switch to the next application in the list of applications. FIG. 9c shows the status of the applications after two third inputs have been received. Application A4 is now marked with a frame indicating that it is currently being displayed as a main application.

If a second input in the form of a tactile input representing a shaking motion is received, e.g. the user shakes the device, the controller is arranged to mark the currently displayed application A4 as an alternate application. In FIG. 9d this is indicated by A4 being underlined and in bold characters. The alternate list structure has also been re-arranged by the controller and two arched lines connect the alternate applications A2, A4 and A5, one going from A2 to A4 and one going from A4 to A5. It should be noted that in all embodiments using such an alternate list structure the alternate list structure may also be looped or circular. This is not indicated in the figures to keep them uncluttered.

In an alternative embodiment, see FIG. 10 which uses the list structure of FIG. 8, a user can order an application switch to an alternate application A2 or A5 by providing a first input, in this embodiment a tactile input representing a twisting motion. In FIG. 10a an alternate application A2 is currently being displayed as a main application. A user twists a device (not shown) implementing a user interface according to this embodiment and a controller receives the first input. The controller selects the other alternate application A5 to be switched to and displays it as a main application. See FIG. 10b where application A5 is marked with a frame as being currently displayed as a main application. Note that the controller has selected an application A5 being “behind” the currently displayed application A2 as it is arranged to switch to an alternate application upon receipt of a first input. If a further first input would be received the controller would switch and display application A2 as a main application, i.e. return to FIG. 10a.

If a user provides a third input the controller is arranged to switch to the next application in the list of applications. In one embodiment the controller is arranged to switch to an application not being an alternate application upon receipt of a third input. FIG. 10c shows the status of the applications after two third inputs have been received. For the first received third input the first application not being an alternate application was displayed as a main application and after receipt of the second third input application A4 is now marked with a frame indicating that it is currently being displayed as a main application.

If a second input in the form of a tactile input representing a shaking motion is received, i.e. the user shakes the device, the controller is arranged to mark the currently displayed application A4 as an alternate application. In FIG. 10d this is indicated by A4 being underlined and in bold characters. The controller has also re-arranged the list so that the newly marked application A4 is now arranged adjacent alternate applications A2 and A5.

In the embodiments above the third input is a received press on a physical or virtual key. Such a key can be a navigational key or a dedicated application switching button.

In one embodiment the controller is further arranged to show a list of the applications currently being executed to provide a user with an overview of the available applications and their order relative each other.

In one embodiment where the controller is arranged to receive a twisting action to switch to a second application a twist backwards causes the controller to switch to an application marked as an alternate and a twist forwards causes the controller to switch to non-alternate or unmarked.

In one embodiment where the controller is arranged to receive a twisting action to switch to a second application a twist causes the controller to switch to an application marked as an alternate and a press on a navigation key causes the controller to switch to an application being next in a list of applications.

In one embodiment the controller is arranged to jump back and forth between marked applications for tactile input and through the whole list of applications for key originating input. A twist to the left thus causes a switch to the marked application to the left in the list of marked applications and a twist to the right causes a switch to the application to the right. A navigation key input indicating a left direction causes a switch to an application to the left in the list of applications (marked and unmarked). A navigation key indicating right direction causes a switch to an application to the right in the list. A shaking motion causes the currently displayed application to be marked.

In one embodiment a controller is arranged to unmark an application if a tactile input indicating a marking action is received when the currently displayed application is a marked or alternate application.

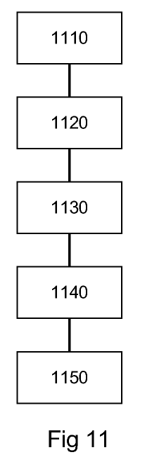

FIG. 11 shows a flow chart of a method according to an embodiment. It should be understood that this is a general description of the methods described in connection with the user interface(s) above. In an initial step 1110 a first application is displayed as a main application on a device such as described above. In a second step 1120 a first input is received and a second application is switched to and displayed as a main application. In a further step 1130 a second input is received whereupon the second application is marked as an alternate application 1140. In a final step 1150 a third input is received whereupon a further application is switched to and displayed as a main application.

It should also be understood that the order of steps 1110+1120 and 1130+1140 and 1150 is not crucial to the teachings herein and depend on the current operating status of an apparatus implementing the method. The example embodiments described with reference to FIGS. 4 to 10 illustrate this.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers or any other device designed for providing information while maintaining low power consumption.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a switch between two of a plurality of allocations can be made easily and intuitively.

Another exemplary advantage of the teaching of the present application is that a user will be able to switch between favorite applications independently of their order in a list of applications.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. A user interface comprising a controller, wherein said controller is arranged to execute a first and a second application and to display the first application as a main application, wherein said controller is further arranged to receive a first input and in response thereto display the second application as a main application.

2. A user interface according to claim 1, wherein said controller is further arranged to receive a second input and mark the displayed application as an alternate application.

3. A user interface according to claim 2, wherein said second application is an alternate application.

4. A user interface according to claim 1, wherein said controller is arranged to mark said first application as an alternate application upon receipt of said first input.

5. A user interface according to claim 3, wherein said controller is further arranged
to maintain a list of a plurality of applications, wherein at least one of said applications is marked as an alternate application, and
to receive a first input and to display an alternate application as a main application in response thereto or
to receive a third input and display a next application in said list of applications as a main application in response thereto.

6. A user interface according to claim 2, wherein said controller is further arranged to receive non-tactile input and to display an application as a main application in response thereto, said application not being an alternate application.

7. A user interface according to claim 1, wherein said first input represents a direction and said second application is selected according to said direction of said first input.

8. An apparatus comprising or arranged to comprise a user interface according to claim 1.

9. A computer readable medium comprising at least computer program code for controlling a user interface comprising a display, said computer readable medium comprising:
software code for executing a first and a second application,
software code for displaying the first application as a main application, and
software code for receiving a first input and in response thereto displaying the second application as a main application.

10. An apparatus incorporating and implementing a computer readable medium according to claim 9.

11. A method for switching between a first and a second application comprising:
displaying the first application as a main application,
receiving a first input, and
in response thereto displaying the second application as a main application.

12. A method according to claim 11, further comprising receiving a second input and marking the displayed application as an alternate application.

13. A method according to claim 12, wherein said second application is an alternate application.

14. A method according to claim 11, further comprising marking said first application as an alternate application upon receipt of said first input.

15. A method according to claim 13, further comprising
maintaining a list of a plurality of applications, wherein at least one of said applications is marked as an alternate application,
receiving a first input and displaying an alternate application as a main application in response thereto or
receiving a third input and displaying a next application in said list of applications as a main application in response thereto.

16. A method according to claim 12, further comprising receiving non-tactile input and displaying an application as a main application in response thereto, said application not being an alternate application.

17. A method according to claim 11, wherein said first input represents a direction and said second application is selected according to said direction of said first input.

18. An apparatus incorporating or arranged to incorporate a method according to claim 11.

19. A user interface comprising control means for executing a first and a second application,
for displaying the first application as a main application,
for receiving a first input and in response thereto displaying the second application as a main application.
